(19) United States
(12) Patent Application Publication
(10) Pub. No.: US 2026/0371161 A1
(43) Pub. Date: Nov. 19, 2026

(54) PROCESSING COMMUNICATIONS FOR A WIRELESS TELECOMMUNICATIONS NETWORK

(71) Applicant: T-Mobile USA, Inc., Bellevue, WA (US)

(72) Inventors: Ugandhar Dasi, Alpharetta, GA (US); Chaitanya Laxminarayana, Austin, TX (US); Ankur Mattoo, Newcastle, WA (US)

(21) Appl. No.: 19/206,878

(22) Filed: May 13, 2025

(51) Int. Cl. H04W 28/06; H04L 41/16; H04W 4/24

(52) U.S. Cl. CPC H04W 28/06; H04L 41/16; H04W 4/24

(57) ABSTRACT

Systems and methods for processing communications are described herein. In some aspects, the system receives a data stream for a communication and a number of iterations required to process the data stream. For a first iteration, the system processes, using a generative model, the data stream to generate a first compressed version. The system, in response to determining that performance of the first compressed version does not meet or exceed a performance metric for the first iteration, adjusts the number of iterations required to process the data stream. For a second iteration, the system processes, using the generative model, the data stream to generate a second compressed version. The system, in response to determining that performance of the second compressed version meets or exceeds a performance metric for the second iteration, for a third iteration, processes, using the generative model, the data stream to generate a final compressed version.

### BACKGROUND

In the rapidly evolving landscape of wireless telecommunications, user retention has become a critical focus for service providers. The competitive nature of the industry, coupled with the increasing availability of alternative service options, has made it imperative for providers to maintain high levels of customer satisfaction. One of the key aspects influencing user retention is the quality of communication between users and agents of the wireless telecommunications network. Users often have complex and varied queries that require detailed and specific responses, ranging from technical issues and billing inquiries to service upgrades and troubleshooting connectivity problems.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates components of a system for processing communications for a wireless telecommunications network, according to at least some aspects of the present technology.

FIG. 3 is a flow diagram that illustrates an example process for processing communications for a wireless telecommunications network, according to at least some aspects of the present technology.

FIG. 4 is another flow diagram that illustrates an example process for processing communications for a wireless telecommunications network, according to at least some aspects of the present technology.

FIG. 5 is a block diagram that illustrates an example of a computer system in which at least some operations described herein can be implemented.

FIG. 6 is a block diagram illustrating an example generative model that can be used to implement at least some aspects of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Customer retention is a critical challenge for wireless telecommunications networks. The telecommunications industry faces significant competition with various options (e.g., service providers) available to the consumers (e.g., users needing a service provider). Users have multiple service provider options to select from, making switching service providers an easy decision and process. High churn rates can lead to substantial revenue losses and increased costs associated with acquiring new customers. Understanding the reasons behind user dissatisfaction and addressing them promptly is essential for maintaining a loyal customer base.

Churn, or the rate at which customers leave a service, is influenced by various factors. Common reasons for churn in wireless telecommunications networks include billing issues, poor customer service, network reliability, and lack of competitive pricing. Users often experience frustration when their concerns are not addressed effectively, leading users to seek alternative service providers. Identifying and resolving the churn issues in a timely manner is crucial for reducing churn rate.

Processing communications between users and agents involves several technical challenges. One of the key technical aspects is the ability to handle complex and varied user queries, which can range from technical issues and billing inquiries to service upgrades and troubleshooting connectivity problems. The diversity and complexity of these queries suggest the need for a robust and flexible communication processing system. Additionally, users expect personalized responses tailored to their specific needs and history with the service provider, which implies that the system should have access to comprehensive user profiles and interaction histories. Addressing these technical challenges can contribute to maintaining an efficient and reliable communication processing system in wireless telecommunications networks.

One specific technical problem is how to condense or compress a data stream (e.g., a call transcript between a user and an agent) to a compression version of the data stream (e.g., a summary or keywords) that is still sufficiently representative of the data stream. A single pass through the data stream using a generative model may not produce a compressed version that meets the desired performance metrics. The performance of intermediate versions of the compressed data stream can vary, necessitating an adaptive approach to determine the optimal number of iterations required for processing.

The systems and methods disclosed herein address this technical problem by processing such communications in a manner that adaptively determines the number of iterations needed to generate a suitable compressed version of the data stream. The system receives a data stream for a communication and an initial number of iterations required to process the data stream. For the first iteration, the system processes the data stream using a generative model to generate a first compressed version of the data stream. The performance of this first compressed version is then evaluated against a predefined performance metric. If the performance of the first compressed version does not meet or exceed the performance metric, the system adjusts the number of iterations required to process the data stream. This adjustment is based on the performance of the intermediate compressed version, allowing the system to adaptively determine the optimal number of iterations.

For subsequent iterations, the system processes the data stream again using the generative model to generate further compressed versions. The performance of each compressed version is evaluated similarly. If the performance of a compressed version meets or exceeds the performance metric, the system proceeds to the next iteration, where it processes the data stream to generate a final compressed version. This final version is expected to be a concise and representative summary of the data stream.

By iteratively processing the data stream and adaptively adjusting the number of iterations based on the performance of intermediate compressed versions, the system ensures that the final compressed version meets the desired performance metrics. This approach enhances the efficiency and accuracy of summarizing data streams, addressing the technical challenges associated with processing extensive and detailed communication data streams.

In some aspects, the systems and methods disclosed herein provide for adaptively processing communications between a user and an agent of a wireless telecommunications network to address user retention. The system (e.g., referred to as the data stream processing system) ensures that communication data (e.g., a data stream containing a summary of the conversation between a user and an agent) is efficiently processed and analyzed to generate actionable recommendations for retaining users. By leveraging machine learning models and generative models, the data stream processing system can improve the compression (e.g., reducing a lengthy call transcript to a summary and/or keywords) and analysis of communication data, to improve user satisfaction and reduce churn rates.

The data stream processing system receives a data stream for a communication between a user and an agent of a wireless telecommunications network. The data stream can include various forms of communication data, such as call transcripts, chat logs, or other interaction records. The data stream can serve as the raw input of data that will be processed to extract meaningful information used to proactively retain (e.g., prevent user from switching to a different service provider) the user. For example, the data stream can comprise a call transcript between a user and a customer service agent discussing billing issues.

The data stream processing system determines whether a time parameter associated with the data stream meets or exceeds a threshold (e.g., a predefined duration) required for processing the data stream. For example, the time parameter can represent the duration of the communication between two individuals, such as a user for a service provider and an agent discussing any topic relating to the service from the service provider. If the time parameter meets or exceeds the threshold, the data stream processing system proceeds to the next operation. The threshold can allow the data stream processing system to only process communications of sufficient length (e.g., longer calls yield more information to process). For example, communications (e.g., phone calls, video calls, online chats, or other communication methods) between the user and the agent that last more than five minutes may be considered the sufficient length to contain enough data for further processing with the data stream processing system.

The data stream processing system then determines the number of iterations required to process the data stream based on the time parameter. The data stream processing system can use a machine learning model to determine the number of iterations. Each iteration can increase the level of compression (e.g., reduce the length of information from call transcripts, chat logs, or other interaction records) of the data stream. Each level of compression can be associated with a performance metric for evaluating the compressed version of the data stream. The performance metric can ensure that the data stream is compressed efficiently while maintaining the quality of the information. For example, longer communications (e.g., phone calls between two people) can require more iterations to achieve the required compression of the data stream to produce data to address user retention, while a shorter call can require fewer iterations to achieve the required compression of the data stream based on the performance metric.

For the first iteration, the data stream processing system uses a generative model to process the data stream to generate a first compressed version (e.g., summarize the communication between one or more people) of the data stream (e.g., call transcript). The data stream processing system then can determine, using a second machine learning model, whether the performance of the first compressed version of the data stream meets or exceeds the performance metric for the first iteration. The performance metric can ensure that the first compressed version of the data stream retains the necessary information quality to address any challenges or positive interactions that may have transpired during communications between two people. If the performance of the first compressed version of the data stream does not meet or exceed the performance metric, the data stream processing system can adjust the number of iterations required to further process (e.g., compress the data stream for the required information) the data stream. The adjusted number of iterations can include three or more iterations.

For the second iteration, the data stream processing system uses the generative model to generate a second compressed version of the data stream. The second compressed version of the data stream can be more compact than the first compressed version. The iterative process can continue until a compressed version meets the criteria of the performance metric. For example, the second iteration may produce a more compact version of the call transcript while retaining key information about the user's billing issue, such as the specific issues addressed in the communications, the user's account details, and the resolution steps discussed to ensure that important data is preserved for further processing (e.g., more compression, analysis, or recommendation generation).

The data stream processing system then determines whether the performance of the second compressed version of the data stream meets or exceeds a second performance metric for the second iteration. If the performance of the second compressed version meets or exceeds the performance metric, the data stream processing system can proceed with subsequent iterations. For these subsequent iterations, the data stream processing system can use a generative model to generate a final compressed version of the data stream. The final compressed version is optimized for both size and information quality. For example, the final compressed version can produce information (e.g., keywords that pinpoint the importance of the call transcript between two people) to address user retention for service providers.

The data stream processing system can process the final compressed version of the data stream to generate multiple recommended actions for display to the agent. These recommended actions are designed to help retain the user with the wireless telecommunications network by addressing the specific issues or concerns identified during the communication. By providing targeted recommendations, the data stream processing system can improve user satisfaction and reduce churn rates. For example, if the user's billing issue is identified as a common concern, the agent may receive a recommendation to offer a billing adjustment or a loyalty discount.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

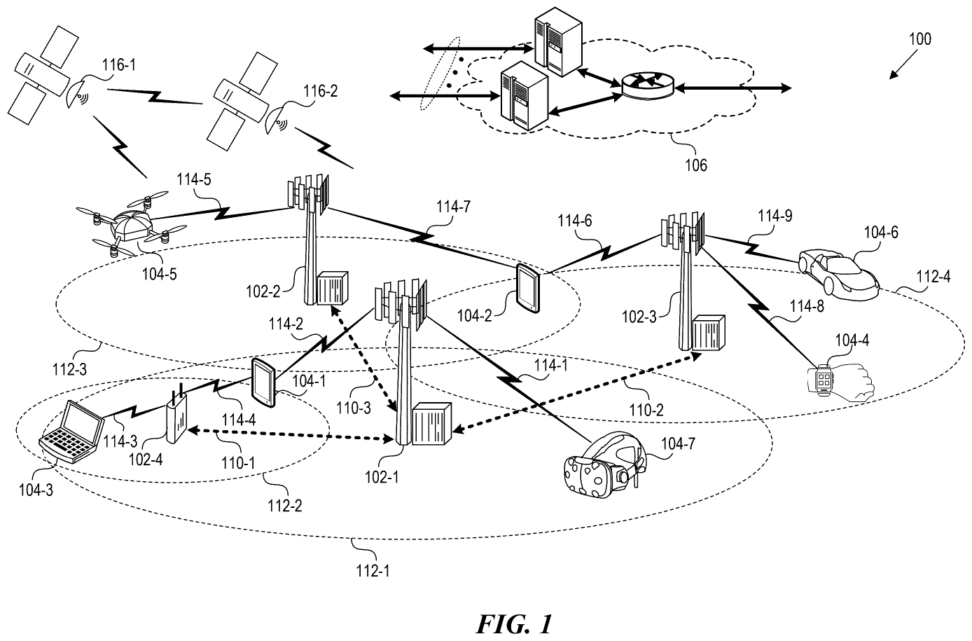

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station as compared to a macro cell and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100, including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Example System(s) for Processing Communications

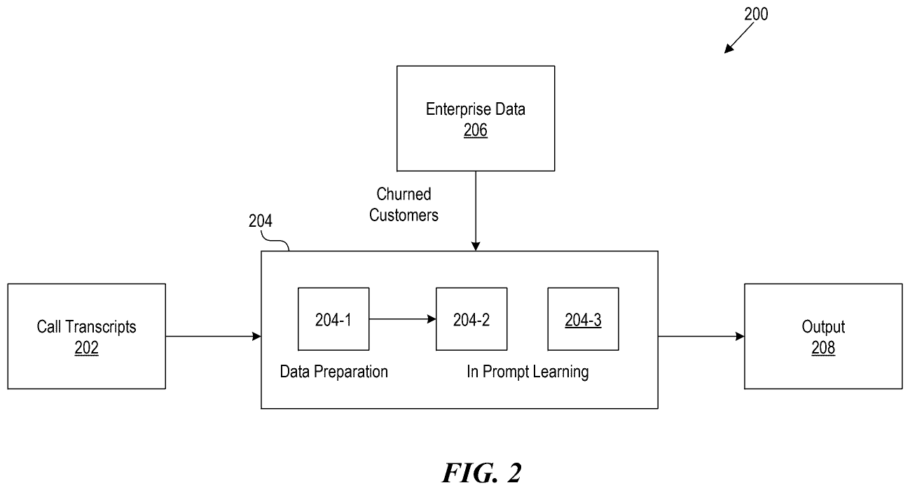

FIG. 2 is a block diagram that illustrates a system 200 that can implement some aspects of the disclosed technology to adaptively process communications between a user and an agent of a wireless telecommunications network to address user retention. For example, the system 200 can receive a data stream for a communication between a user and an agent of a wireless telecommunications network. The system 200 can comprise various components, such as communications data 202, data processor 204, enterprise data 206, and output 208. System 200 can use the various components to process the flow of data (e.g., data stream comprising call transcripts between a user and an agent) through the application of in-prompt learning algorithms to generate actionable recommendations for user retention.

In the illustrated implementation, system 200 can process a data stream that comprises communications data 202 between a user and an agent for a wireless telecommunications network. Communications data 202 can include call transcripts, chat logs, or other interaction records that occurred between the user and the agent. Communications data 202 can comprise a data stream that includes the interactions and issues discussed between the user and the agent that form the raw input for further processing. In one implementation, the system 200 can determine whether a time parameter associated with the data stream meets or exceeds a threshold required for processing the data stream that includes communications data 202.

In the illustrated implementation, system 200 can process communications data 202 via data processor 204. In-prompt learning can occur at the data processor 204. Before in-prompt learning takes place, data processor 204 can process (e.g., data preparation) communications data 202. Data processor 204 can comprise a computational infrastructure with multiple components that provide an environment to prepare communications data 202 from raw input data (e.g., initial data stream iteration) to recommended actions (e.g., output based on final data stream iteration) to address user retention. The computational infrastructure for data processor 204 can comprise data processor 204-1, data processor 204-2, and data processor 204-3 and determine whether a time parameter associated with the data stream meets or exceeds a threshold required for processing the data stream. In some implementations, the system 200 can determine, using a machine learning model from the data processor 204, based on the time parameter, a number of iterations required to process the data stream. Each iteration can increase a level of compression of the data stream. Each iteration can be associated with a performance metric for evaluating a compressed version of the data stream.

Data processor 204-1 can ingest and process (e.g., transform and clean data for use in analytics or machine learning) large or small volumes of raw data, such as communications data 202. Data processor 204-1 (e.g., AZURE DATABRICKS) can extract, transform, and load communications data 202 such as call transcripts to prepare the data for subsequent analysis. For example, each iteration generated by data processor 204-1 can increase a level of compression of the communications data 202.

Data processor 204-2 can be a generative model (e.g., large language model) that further processes the iteration of communications data 202 already processed by the data processor 204-1 to continue the in-prompt learning process for system 200. Data processor 204-2 can process the prepared data (e.g., compressed version) to provide a better understanding to the context and nuances of the communications data 202 between the user and the agent for the wireless telecommunications network to better determine how many iterations of the data stream require more compression. For example, each iteration can be associated with a performance metric for evaluating a compressed version of the communications data 202.

Data processor 204-3 can be a component (e.g., Graphical Processing Units) integrated into data processor 204 to accelerate the computational tasks associated with in-prompt learning and data processing. Data processor 204-3 can ensure efficient performance and speed in handling large volumes of the communications data 202. In some implementations, the system 200 can use components from data processor 204 to process a first iteration of the communications data 202 using a generative model to generate a first compressed version of the data stream. Furthermore, in some implementations, the system 200 can determine whether the performance of the first compressed version of communications data 202 meets or exceed a performance metric for the first iteration using a machine learning model from the components in data processor 204. In some implementations, the system 200 can use components from data processor 204 to process a second iteration of the communications data 202 using a generative model to generate a second, more compressed version of the data stream. Furthermore, in some implementations, the system 200 can determine whether the performance of the second compressed version of communications data 202 meets or exceeds a performance metric for the second iteration using a machine learning model from the components in data processor 204. In some implementations, the system 200 can use components from data processor 204 to process subsequent iterations of the communications data 202 using a generative model to generate a final compressed version of the data stream.

Enterprise data 206 can be a component (e.g., repository) of system 200 that includes historical data related to the wireless telecommunications network's user base, particularly focusing on churned customers (e.g., users that deactivated their service with the wireless telecommunications network). Enterprise data 206 can comprise information such as user demographics, account details, service usage patterns, past interactions, and reasons for user churn. The data provided from enterprise data 206 can enrich the raw data from communications data 202 (e.g., call transcripts, chat logs) by providing context for each user's interaction history. By integrating enterprise data 206 and communications data 202 into data processor 204, system 200 can more accurately identify patterns and trends that contribute to user churn. For example, the historical data from enterprise data 206 collected from various users in regard to billing issues can be compared by the system 200 with the current communication records (e.g., communications data 202) between a user and an agent to identify patterns associated with user churn for billing issues. Data processor 204 can utilize both communications data 202 (e.g., call transcript) and enterprise data 206 (e.g. historical data) to improve model training and generate more accurate user retention recommendations.

The data processor 204 of system 200 can process the data stream (e.g., communications data 202 and enterprise data 206) to generate output 208. Output 208 can include actionable recommendations designed to address user retention. The actionable recommendations can be tailored responses to specific user issues identified during the analysis of the communications data 202 between the user and an agent for a wireless telecommunications network. For example, if the system 200 can process communications data 202 and determine that a user has contacted support (e.g., agents for a service provider) regarding billing disputes, the output 208 can include recommended actions generated to retain the user such as offering billing adjustments, providing detailed bill explanations, or granting loyalty discounts. The system 200 can ensure that these recommendations are presented to the agent in an easily actionable format, optimizing their ability to address user concerns promptly and effectively, thereby reducing churn rates and enhancing customer loyalty.

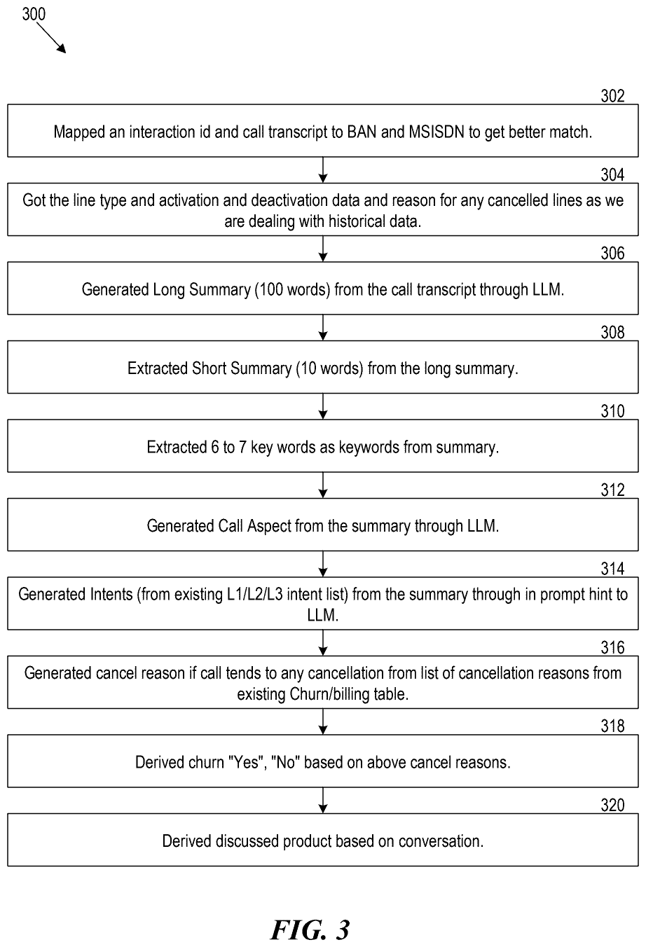

FIG. 3 is a flowchart that illustrates an example process 300 that can implement some aspects of the disclosed technology to adaptively process communications between a user and an agent of a wireless telecommunications network to address user retention. Process 300 can include processing communication data between the user and the agent and generating retention-related insights using a combination of historical data and natural language processing techniques.

At operation 302, the system 200 can map each interaction identifier (e.g., interaction ID) and corresponding call transcript to a subscriber identity, such as a Billing Account Number (BAN) and Mobile Station International Subscriber Directory Number (MSISDN). The mapping of each interaction identifier can ensure that communication data is associated with the correct customer account, enabling accurate contextual analysis during subsequent operations. For example, the mapping of each interaction identifier can be performed via a database join operation, or a lookup function that links call metadata with subscriber records.

At operation 304, the system 200 can retrieve account type and line details associated with the identified BAN and MSISDN. The line details can include attributes such as line type (e.g., voice line, mobile internet, high-speed internet), activation date, deactivation date, and cancellation reason if applicable. Operation 304 can provide context for behavioral analysis by capturing life cycle events relevant to customer engagement and retention. For example, after mapping a call interaction to BAN and MSISDN, the system 200 can retrieve account type and line details from the account associated with the user (e.g., customer of the service provider). The retrieved records can indicate that the line is an account with high-speed internet originally activated on Jan. 5, 2025, and that a secondary line under the same account was deactivated on Mar. 20, 2025. The deactivation record can include a cancellation reason such as network coverage dissatisfaction. The data from the account type and line details can provide insight into the customer's prior service activity and potential drivers of dissatisfaction, which can be used to contextualize the current interaction and support predictive modeling of churn risk.

At operation 306, a long-form summary can be generated from the call transcript using a large language model. The summary is approximately 100 words in length and provides a condensed (e.g., compressed data) yet comprehensive representation of the main topics and sentiments expressed during the communications between the user and the agent. For example, the call transcript linked to the BAN can include a five-minute conversation in which the customer (e.g. user) reports recurring billing discrepancies, confusion over promotional charges, and dissatisfaction with recent customer service responses. A large language model (e.g., generative model) can process the call transcript and generate a long-form summary of approximately 100 words. The summary can include information regarding that the customer called to dispute charges on their latest bill, cited ongoing issues with incorrect fees over the past three billing cycles, and expressed frustration with delayed resolution timelines. The customer can also mention considering switching service providers if the problem is not resolved promptly. This compressed representation captures the key themes of the interaction, including the customer's concerns, sentiment, and intent, which are used for further classification and retention analysis.

At operation 308, a short-form summary comprising approximately 10 words is extracted from the long-form summary. This condensed summary provides a high-level indication of the interaction's core theme or customer concern. For example, based on the long-form summary generated in operation 306, the system 200 can extract a short-form summary consisting of approximately 10 words, such as “Recurring billing errors, customer frustrated and considering service cancellation.” This condensed summary can provide a high-level description of the core issue discussed in the call, enabling quick identification of the primary concern extracted from the communications between the user and agent without reviewing the full transcript or long summary.

At operation 310, a predefined number (e.g., five to seven) of keywords are extracted from the long-form summary or short-form summary. The keywords can represent terms or recurring themes within the communications between the user and agent to support indexing, categorization, and relevance scoring in downstream processes. For example, from the short-form summary generated in operation 308, the system 200 can extract six keywords that reflect the main topics and sentiments expressed during the interaction: “billing,” “overcharges,” “frustration,” “refund,” “customer service,” and “cancellation.” These keywords can represent important terms mentioned throughout the call that can be used to index the conversation in the system 200 database, facilitate search and retrieval, and support categorization and relevance scoring for analytics, such as churn prediction or escalation prioritization.

At operation 312, the system 200 applies the large language model to classify the overall aspect of the call. The call aspect can include categories such as complaint, inquiry, service request, or feedback. The classification provides context for understanding the customer's intent and tone. For example, based on the content of the long-form summary and extracted keywords, the system 200 can apply the large language model at operation 312 to determine the overall aspect of the call. In one implementation, the large language model can classify the interaction as a “complaint,” reflecting the customer's dissatisfaction with repeated billing errors and poor resolution experiences. This classification helps contextualize the customer's tone and intent, signaling that the call was driven by a negative experience rather than a neutral inquiry or routine service request.

At operation 314, one or more intents can be generated from the long-form summary. The system 200 can use in-prompt hinting with the large language model and references a predefined taxonomy of hierarchical intents (e.g., Level 1, Level 2, and Level 3 intents). Operation 314 can help structure categorization of the purpose for the communications between a user and an agent, such as billing inquiry, late fee dispute, or refund request. For example, using in-prompt hinting, the system 200 can apply the large language model to the long-form summary and map the conversation between the user and the agent to a predefined intent hierarchy. In one implementation, the system 200 can identify the following hierarchical intents, such as Level 1—“Billing Inquiry,” Level 2—“Incorrect Charges,” and Level 3—“Refund Request.” The hierarchal intents can provide a granular understanding of the communication's (e.g., call transcript, chat logs) purpose, allowing other components of the system 200 to route the issue appropriately, prioritize follow-up actions, or apply targeted retention (e.g., recommended actions to retain user) strategies based on the specific billing concern raised by the customer.

At operation 316, the system 200 can determine whether the communications between the user and the agent indicates a potential service cancellation. If the communications suggest the user is likely to cancel their line with the service provider, a cancellation reason can be generated by referencing a predefined list of reasons stored in a churn database. The cancellation reason can provide a specific explanation, such as “pricing dissatisfaction” or “network coverage issue.” For example, during analysis of the content of the communications between the user and the agent, the system 200 can detect language indicating a potential intent to cancel, such as the customer stating, “If this happens again, I'm switching providers.” At operation 316, the system 200 can reference a predefined list of cancellation reasons stored in the churn database and can select “pricing dissatisfaction” as the most applicable reason based on the context of the billing-related complaints. This cancellation reason is then associated with the interaction record (e.g., communications in form of a call transcript or chat log), providing a specific and actionable explanation (e.g., recommended action) for the customer's cancellation risk.

At operation 318, based on the cancellation indicators identified in operation 316, the system 200 can assign a churn status (e.g., performance metric) to the customer (e.g. user communicating with an agent for a service provider). The churn status can be binary (e.g., “Yes” for likely to churn, “No” for not likely to churn) and can be stored for use in predictive models and retention workflows. For example, based on the identified cancellation indicator “pricing dissatisfaction” from operation 316 and the customer's explicit statement about switching providers, the system 200 can assign a churn status of “Yes” at operation 318. The “Yes” status can indicate a high likelihood that the customer may terminate their service. The churn status is stored in the customer's profile and can be used by predictive retention models or customer care systems to trigger proactive outreach, personalized offers, or escalation to customer retention teams.

At operation 320, the system 200 can identify one or more products or services discussed during the communications between the user (e.g., customer) and the agent. Identifying multiple products or services can be performed via a natural language processing component or keyword matching against a predefined product list. The derived product information can provide insights into the focus of the customer's call and can be used for targeted follow-up, upselling, or service improvement. For example, the system 200 can analyze the call transcript using natural language processing-based entity recognition to identify references to the “Premium Family Plan,” which is included in a predefined product catalog. If the customer specifically mentions issues related to billing for that plan, including unexpected charges and unclear promotional terms, the system 200 can tag the interaction with the product information, allowing downstream processes to associate the issue with a specific service. The process occurring at operation 320 can provide targeted follow-up by support teams, tailored retention offers related to the plan, and internal reporting on product-specific pain points.

The operations described in connection with process 300 and illustrated in FIG. 3 do not necessarily need to be performed in the precise sequence shown. In some implementations, one or more operations can be executed in parallel or in a different order, depending on system architecture, processing efficiency, or available data. For example, operations such as summary generation, keyword extraction, and product identification may be performed concurrently once the call transcript is available. Similarly, historical data retrieval and churn status determination may be initiated independently of summary generation. The flexibility in execution order can allow the system 200 to adapt to real-time processing requirements or batch processing workflows without departing from the scope of the technology.

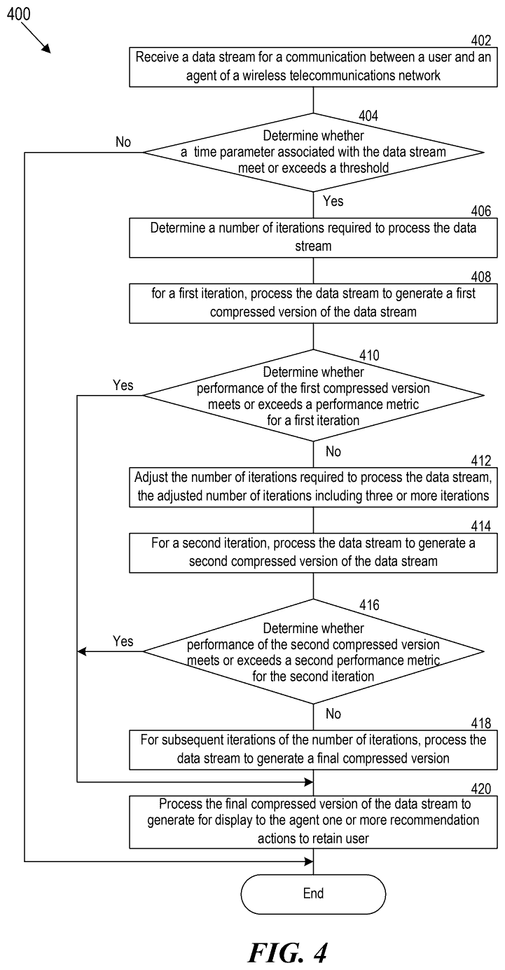

FIG. 4 is a flowchart 400 of operations for adaptively processing communications between a user and an agent of a wireless telecommunications network to address user retention, in accordance with one or more implementations of this disclosure.

In operation 402, the system 200 receives a data stream for a communication between a user and an agent of a wireless telecommunications network. This data stream can include various formats such as audio, text, video, or other communication logs. Operation 402 gathers the raw communication data between the user and the agent necessary for the subsequent analytical and processing operations. The data stream is captured in real time or retrieved from stored communication records to ensure all relevant interaction data is obtained for processing.

At operation 404, the system 200 determines whether a time parameter associated with the data stream meets or exceeds a threshold required for processing the data stream. The time parameter can represent the duration of the communication between the user and the agent, ensuring that only interactions of sufficient length are considered for further analysis. This threshold can be predefined based on the minimum interaction length required to derive meaningful insights. If the communication duration meets or exceeds the threshold, the process moves to the next operation.

In operation 406, the system 200 determines, using a first machine learning model, the number of iterations required to process the data stream based on the time parameter. Each iteration aims to increase the level of compression of the data stream while retaining the core information. The number of iterations required is influenced by the initial assessment of the data stream's complexity and quality, ensuring optimal processing results.

For operation 408, the system 200 performs the first iteration by processing the data stream using a generative model to generate a first compressed version (e.g., long-form summary of communications between the user and the agent) of the data stream. The first compressed version involves applying initial compression algorithms to reduce the size of the data stream while retaining essential details and context. The first compressed version serves as the baseline for evaluating the effectiveness of the compression.

In operation 410, the system 200 determines, using a second machine learning model, whether the performance of the first compressed version meets or exceeds the performance metric established for the first iteration. Performance metrics can include factors such as data integrity, compression ratio, and retention of critical information. If the performance metrics are met or exceeded, the system 200 proceeds; otherwise, further adjustments are required.

At operation 412, in response to the first compressed version not meeting the performance metric, the system 200 adjusts the number of iterations required to process the data stream. The adjusted number of iterations can include three or more iterations. The adjusted number of iterations ensures that the data stream undergoes adequate processing by the system 200 to reach the compression quality that passes the performance metric while maintaining information integrity.

For operation 414, the system 200 processes the data stream in a second iteration using the generative model to generate a second compressed version. The second iteration further refines the data compression (e.g., short-form summary), making the data stream more compact than the first compressed version. The iterative process helps in progressively improving the quality and efficiency of compression.

In operation 416, the system 200 evaluates the performance of the second compressed version using the second machine learning model to determine whether it meets the performance metric for the second iteration. Consistent evaluation via performance metrics can ensure that each iteration generates the optimal balance between compression and information quality. If the performance metrics are satisfied, the system 200 proceeds; otherwise, additional iterations may be necessary.

For subsequent iterations, as described in operation 418, the system continues processing the data stream using the generative model to generate a final compressed version. The iterative approach ensures that the final output is appropriately compressed and retains the necessary information for generating insights. Each iteration builds upon the previous ones, enhancing the overall compression effectiveness.

In operation 420, the system 200 processes the final compressed version of the data stream to generate one or more recommended actions for display to the agent. The recommended actions are based on the processed data stream that includes communication data between the user and the agent. The recommended actions aim to address user concerns, improve service quality, or suggest solutions to improve user retention. The recommended actions are presented to the agent to support informed decision-making and to help retain the user with the wireless telecommunications network.

In some implementations, determining the one or more recommended actions to retain the user comprises processing, using a second generative model, the final compressed version of the data stream to generate one or more intent levels.

In some implementations, the system 200 generates, using a second generative model, values for a hierarchical data structure based on the one or more intent levels, wherein a first intent level comprises a plurality of categories associated with communications between a user and an agent of a wireless telecommunications network, wherein a second intent level comprises a plurality of subcategories associated with the first intent level, and wherein a third intent level comprises a reason for the communications between a user and an agent of a wireless telecommunications network associated with the second intent level.

In some implementations, the system 200 processes, using the data stream processing system, values for the third intent level to generate one or more recommended actions for user retention based on the reason identified from the communications between a user and an agent of a wireless telecommunications network.

In some implementations, the system 200 analyzes, using the data stream processing system, a sentiment of the communications between a user and an agent of a wireless telecommunications network, wherein the communications are positive, negative, or neutral, and wherein the sentiment provides additional context to the third intent level to improve generation of the one or more recommended actions for user retention.

In some implementations, determining the one or more recommended actions to retain the user comprises processing, using a second generative model, the final compressed version of the data stream to generate one or more attributes.

In some implementations, the system 200 identifies, using a third generative model, one or more attributes from communications between a user and an agent of a wireless telecommunications network, wherein the one or more attributes comprise additional context for the final compressed version, wherein the additional context is user intent not captured in a hierarchical data structure for one or more intent levels.

In some implementations, the system 200 processes, using a third machine learning model, the final compressed version of the data stream to generate a measure of retention of the user of the wireless telecommunications network.

In some implementations, the system 200 performs further adjustments in a number of iterations required to process the data stream, wherein the further adjustments in the number of iterations are based on a performance metric for evaluating a compressed version of the data stream associated with each iteration.

### Computer System

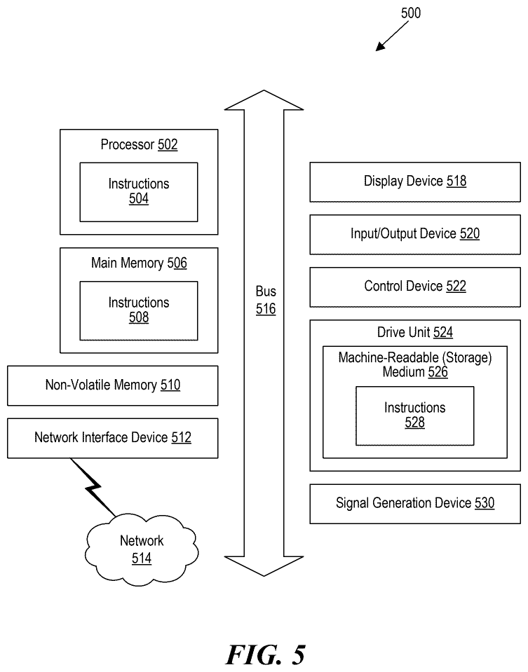

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Transformer for Neural Network

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the model can be a neural network with multiple input nodes that receive input. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input that, once the model is trained, can be used as the output. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

A machine learning model can be trained with supervised learning, where the training data includes input and a desired output. A representation can be provided to the model. Output from the model can be compared to the desired output and based on the comparison, the model can be modified, such as by changing weights between nodes of the neural network or parameters of the functions used at each node in the neural network (e.g., applying a loss function). After applying each of the input in the training data and modifying the model in this manner, the model can be trained to evaluate new input.

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger dataset. For example, a dataset may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger dataset and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed, and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or, in the case of a large language model (LLM), may contain millions or billions of learned parameters or more. As non-limiting examples, a language model can generate text, translate text, summarize text, answer questions, write code (e.g., PYTHON, JAVASCRIPT, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

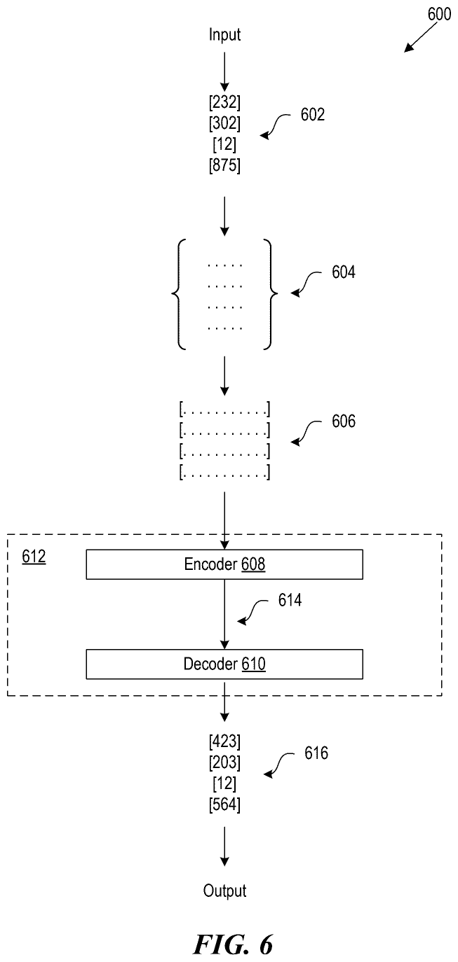

FIG. 6 is a block diagram of an example transformer 612. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any ML-based language model, including language models based on other neural network architectures such as RNN-based language models.

The transformer 612 includes an encoder 608 (which can comprise one or more encoder layers/blocks connected in series) and a decoder 610 (which can comprise one or more decoder layers/blocks connected in series). Generally, the encoder 608 and the decoder 610 each include a plurality of neural network layers, at least one of which can be a self-attention layer. The parameters of the neural network layers can be referred to as the parameters of the language model.

The transformer 612 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 612 is trained to perform certain functions on other input formats than natural language input. For example, the input can include objects, images, audio content, or video content, or a combination thereof.

The transformer 612 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 6 illustrates an example of how the transformer 612 can process textual input data. Input to a language model (whether transformer-based or otherwise) typically is in the form of natural language that can be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 6, a short sequence of tokens 602 corresponding to the input text is illustrated as input to the transformer 612. Tokenization of the text sequence into the tokens 602 can be performed by some pre-processing tokenization module such as, for example, a byte-pair encoding tokenizer (the “pre” referring to the tokenization occurring prior to the processing of the tokenized input by the LLM), which is not shown in FIG. 6 for simplicity. In general, the token sequence that is inputted to the transformer 612 can be of any length up to a maximum length defined based on the dimensions of the transformer 612. Each token 602 in the token sequence is converted into an embedding vector 606 (also referred to simply as an embedding 606). An embedding 606 is a learned numerical representation (such as, for example, a vector) of a token that captures some semantic meaning of the text segment represented by the token 602. The embedding 606 represents the text segment corresponding to the token 602 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 606 corresponding to the “write” token will be closer to another embedding corresponding to the “jot down” token in the vector space as compared to the distance between the embedding 606 corresponding to the “write” token and another embedding corresponding to the “summary” token.

The vector space can be defined by the dimensions and values of the embedding vectors. Various techniques can be used to convert a token 602 to an embedding 606. For example, another trained ML model can be used to convert the token 602 into an embedding 606. In particular, another trained ML model can be used to convert the token 602 into an embedding 606 in a way that encodes additional information into the embedding 606 (e.g., a trained ML model can encode positional information about the position of the token 602 in the text sequence into the embedding 606). In some examples, the numerical value of the token 602 can be used to look up the corresponding embedding in an embedding matrix 604 (which can be learned during training of the transformer 612).

The generated embeddings 606 are input into the encoder 608. The encoder 608 serves to encode the embeddings 606 into feature vectors 614 that represent the latent features of the embeddings 606. The encoder 608 can encode positional information (i.e., information about the sequence of the input) in the feature vectors 614. The feature vectors 614 can have very high dimensionality (e.g., on the order of thousands or tens of thousands), with each element in a feature vector 614 corresponding to a respective feature. The numerical weight of each element in a feature vector 614 represents the importance of the corresponding feature. The space of all possible feature vectors 614 that can be generated by the encoder 608 can be referred to as the latent space or feature space.

Conceptually, the decoder 610 is designed to map the features represented by the feature vectors 614 into meaningful output, which can depend on the task that was assigned to the transformer 612. For example, if the transformer 612 is used for a translation task, the decoder 610 can map the feature vectors 614 into text output in a target language different from the language of the original tokens 602. Generally, in a generative language model, the decoder 610 serves to decode the feature vectors 614 into a sequence of tokens. The decoder 610 can generate output tokens 616 one by one. Each output token 616 can be fed back as input to the decoder 610 in order to generate the next output token 616. By feeding back the generated output and applying self-attention, the decoder 610 is able to generate a sequence of output tokens 616 that has sequential meaning (e.g., the resulting output text sequence is understandable as a sentence and obeys grammatical rules). The decoder 610 can generate output tokens 616 until a special [EOT] token (indicating the end of the text) is generated. The resulting sequence of output tokens 616 can then be converted to a text sequence in post-processing. For example, each output token 616 can be an integer number that corresponds to a vocabulary index. By looking up the text segment using the vocabulary index, the text segment corresponding to each output token 616 can be retrieved, the text segments can be concatenated together, and the final output text sequence can be obtained.

In some examples, the input provided to the transformer 612 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A system for adaptively processing communications between a user and an agent of a wireless telecommunications network to address user retention, the system comprising:
at least one hardware processor; and
at least one non-transitory memory storing instructions, which, when executed by the at least one hardware processor, cause the system to:
receive a data stream for a communication between a user and an agent of a wireless telecommunications network;
determine whether a time parameter associated with the data stream meets or exceeds a threshold required for processing the data stream;
in response to determining that the time parameter meets or exceeds the threshold, determine, using a first machine learning model, based on the time parameter, a number of iterations required to process the data stream,
wherein each iteration increases a level of compression of the data stream, and
wherein each iteration is associated with a performance metric for evaluating a compressed version of the data stream;
for a first iteration, process, using a generative model, the data stream to generate a first compressed version of the data stream;
determine, using a second machine learning model, whether performance of the first compressed version meets or exceeds a performance metric for a first iteration;
in response to determining that performance of the first compressed version does not meet or exceed the performance metric for the first iteration, adjust the number of iterations required to process the data stream, the adjusted number of iterations including at least a predetermined number of iterations;
for a second iteration, process, using the generative model, the data stream to generate a second compressed version of the data stream, wherein the second compressed version is a more compact version of the data stream compared to the first compressed version;
determine, using the second machine learning model, whether performance of the second compressed version meets or exceeds a second performance metric for the second iteration;
in response to determining that performance of the second compressed version meets or exceeds the performance metric for the second iteration, for subsequent iterations of the number of iterations, process, using the generative model, the data stream to generate a final compressed version; and
process the final compressed version of the data stream to generate for display to the agent one or more recommended actions to retain the user with the wireless telecommunications network.

2. The system of claim 1, wherein determining the one or more recommended actions to retain the user comprises:
processing, using a second generative model, the final compressed version of the data stream to generate one or more intent levels.

3. The system of claim 2, further caused to:
generate, using a second generative model, values for a hierarchical data structure based on the one or more intent levels,
wherein a first intent level comprises a plurality of categories associated with communications between a user and an agent of a wireless telecommunications network,
wherein a second intent level comprises a plurality of subcategories associated with the first intent level, and
wherein a third intent level comprises a reason for the communications between a user and an agent of a wireless telecommunications network associated with the second intent level.

4. The system of claim 3, further caused to:
process values for the third intent level to generate one or more recommended actions for user retention based on the reason identified from the communications between a user and an agent of a wireless telecommunications network.

5. The system of claim 3, further caused to:
analyze a sentiment of the communications between a user and an agent of a wireless telecommunications network,
wherein the communications are positive, negative, or neutral, and
wherein the sentiment provides additional context to the third intent level to improve generation of the one or more recommended actions for user retention.

6. The system of claim 1, wherein determining the one or more recommended actions to retain the user comprises:
processing, using a second generative model, the final compressed version of the data stream to generate one or more attributes.

7. The system of claim 6, further caused to:
identify, using a third generative model, one or more attributes from communications between a user and an agent of a wireless telecommunications network,
wherein the one or more attributes comprise additional context for the final compressed version,
wherein the additional context is user intent not captured in a hierarchical data structure for one or more intent levels.

8. The system of claim 1, further caused to:
process, using a third machine learning model, the final compressed version of the data stream to generate a measure of retention of the user of the wireless telecommunications network.

9. The system of claim 8, further caused to:
perform further adjustments in a number of iterations required to process the data stream,
wherein the further adjustments in the number of iterations are based on a performance metric for evaluating a compressed version of the data stream associated with each iteration.

10. A method for adaptively processing communications between a user and an agent of a wireless telecommunications network to address user retention, the method comprising:
receiving a data stream for a communication between a user and an agent of a wireless telecommunications network and a number of iterations required to process the data stream,
wherein each iteration increases a level of compression of the data stream, and
wherein each iteration is associated with a performance metric for evaluating a compressed version of the data stream;
for a first iteration, processing, using a generative model, the data stream to generate a first compressed version of the data stream;
in response to determining that performance of the first compressed version does not meet or exceed the performance metric for the first iteration, adjusting the number of iterations required to process the data stream, the adjusted number of iterations including at least a predetermined number of iterations;
for a second iteration, processing, using the generative model, the data stream to generate a second compressed version of the data stream, wherein the second compressed version is a more compact version of the data stream compared to the first compressed version;
in response to determining that performance of the second compressed version meets or exceeds the performance metric for the second iteration, for subsequent iterations of the number of iterations, processing, using the generative model, the data stream to generate a final compressed version.

11. The method of claim 10, wherein each iteration increases a level of compression of the data stream.

12. The method of claim 10, further comprising:
integrating one or more machine learning models to a data stream processing system,
wherein a first machine learning model determines a number of iterations required to process the data stream based on a time parameter,
wherein a second machine learning model determines whether performance of the first compressed version meets or exceeds a performance metric for a first iteration,
wherein a third machine learning model predicts a measure of retention of the user of the wireless telecommunications network.

13. The method of claim 10, further comprising:
integrating one or more generative models to a data stream processing system,
wherein a first generative model processes the data stream to generate a first compressed version of the data stream for the first iteration and a second compressed version of the data stream for a second iteration,
wherein a second generative model processes the final compressed version of the data stream to generate one or more intent levels.

14. The method of claim 13, further comprising:
establishing, using the second generative model, a hierarchical structure for the one or more intent levels,
wherein a first intent level comprises a predefined list of categories associated with a general area of concern based on communications between a user and an agent of a wireless telecommunications network,
wherein a second intent level comprises a predefined list of subcategories associated with the first intent level, and
wherein a third intent level comprises a reason for the communications between a user and an agent of a wireless telecommunications network associated with the second intent level.

15. The method of claim 14, further comprising:
processing, using a data stream processing system, the third intent level to generate one or more recommended actions for user retention based on the reason identified from the communications between a user and an agent of a wireless telecommunications network.

16. A non-transitory, computer-readable storage medium comprising instructions recorded thereon, wherein the instructions when executed by at least one data processor of a system, cause the system to:
receive a data stream for a communication and a number of iterations required to process the data stream;
for a first iteration, process, using a generative model, the data stream to generate a first compressed version of the data stream;
in response to determining that performance of the first compressed version does not meet or exceed a performance metric for the first iteration, adjust the number of iterations required to process the data stream;
for a second iteration, process, using the generative model, the data stream to generate a second compressed version of the data stream, wherein the second compressed version is a more compact version of the data stream compared to the first compressed version;
in response to determining that performance of the second compressed version meets or exceeds a performance metric for the second iteration, for a third iteration, process, using the generative model, the data stream to generate a final compressed version.

17. The non-transitory, computer-readable storage medium of claim 16, wherein each iteration increases a level of compression of the data stream.

18. The non-transitory, computer-readable storage medium of claim 16, wherein the instructions further cause the system to:
integrate one or more machine learning models to a data stream processing system,
wherein a first machine learning model determines a number of iterations required to process the data stream based on a time parameter,
wherein a second machine learning model determines whether performance of the first compressed version meets or exceeds a performance metric for a first iteration,
wherein a third machine learning model predicts a measure of retention.

19. The non-transitory, computer-readable storage medium of claim 16, wherein the instructions further cause the system to:
process, using a large language model, the final compressed version of the data stream to generate one or more attributes.

20. The non-transitory, computer-readable storage medium of claim 17, wherein the instructions further cause the system to:
identify, using large language models, one or more attributes from communications between a user and an agent of a wireless telecommunications network,
wherein the one or more attributes comprise additional context for the final compressed version,
wherein the additional context is user intent not captured in a hierarchical structure for one or more intents.
